(19) United States
(12) Patent Application Publication
(10) Pub. No.: US 2001/0010258 A1
(43) Pub. Date: Aug. 2, 2001

(54) Adhesive tape with fold out film

(76) Inventor: George Gruber, Stillwater, MN (US)

Correspondence Address: NIKOLAI MERSEREAU & DIETZ, P.A., 820 INTERNATIONAL CENTRE, 900 SECOND AVENUE SOUTH, MINNEAPOLIS, MN, 55402

(21) Appl. No.: 09/809,902

(22) Filed: Mar. 16, 2001

Related U.S. Application Data
(63) Continuation-in-part of application No. 09/374,406, filed on Aug. 13, 1999.

(51) Int. Cl. B44C 7/00

(52) U.S. Cl. 156/577

(57) ABSTRACT

A dispenser and tape/film combination that dispenses and applies a tape/film to a first surface, wherein an edge of the tape is precisely positioned either flush or a predetermined distance from an adjacent second surface. The dispensing system of the present invention allows for bi-directional application of the tape/film to the first surface and is particularly well suited for applying the tape/film both around and into corners. The dispenser and tape/film combination further provides for an automatic alignment of an outer edge of a core of the tape/film relative to the dispenser frame independent of the thickness of the core of the tape/film.

This patent application is a continuation-in-part of co-pending application Ser. No. 09/374,406 filed Aug. 13, 1999.

### I. FIELD OF THE INVENTION

This invention relates generally to devices that dispense a continuous strip of tape having a fold-out film attached thereto, and more particularly relates to a tape dispenser that dispenses and applies a tape/film combination to a first surface. The edge of the tape is precisely positioned either flush or a predetermined distance from an adjacent second surface, and the fold-out film may be extended, thereby covering an additional portion of the first surface. The tape dispensing system of the present invention allows for bi-directional application of the tape/fold-out film combination to the first surface and is particularly well suited for applying tape both around and into corners. The tape dispenser system further provides for an automatic alignment of an outer edge of a roll of tape relative to the dispenser frame independent of the thickness of the roll of tape/film combination. The tape dispenser and tape/film combination eliminates the need for multiple rolls of tape and films and/or complex dispensing systems.

### II. BACKGROUND OF THE INVENTION

At various times it is desirable to precisely apply a strip of tape to a first surface, such as a baseboard, wherein an edge of the strip of tape is consistently spaced a pre-determined distance from an adjacent second surface, such as a wall. It may further be desirable to include an additional paper, foil, plastic, etc. attached to the tape to further cover the first surface. For ease of discussion and without limitation, the first surface will be referred to herein as a baseboard or other trim and the second adjacent surface will be referred to herein as a wall. Although the user may manually remove a strip of tape from a roll of tape and then apply this strip to an edge of the baseboard adjacent the wall and further attach a paper or plastic to the tape, the removal, attachment, and alignment process is time consuming and imprecise. It has been found to be both desirable and efficient to apply a strip of tape to the baseboard from a tape applicator or dispenser.

In the past, tape applicators have been provided that apply tape to a baseboard, for example, requiring manual alignment of the tape's edge to the adjacent wall. G. J. Kefalos in U.S. Pat. No. 3,537,942 describes a tape applicator having a hub and cylindrical alignment roller that may be used to apply tape to a baseboard adjacent a wall. The hub is adapted for receiving a roll of tape, wherein the roll of tape is pressed onto the hub until an inner edge of the roll of tape engages against a rear flange of the hub. The user must then manually adjust the alignment roller such that the outer edge of the alignment roller aligns with the outer edge of the roll of tape. Each time a new roll of tape is engaged to the hub, the alignment roller should be accordingly adjusted. Apparently, the dispenser described by Kefalos allows the user to apply tape to the baseboard with an edge of the tape positioned flush with the wall. It is desirable, however, to eliminate the need for manual adjustments of an alignment member each time a roll of tape is replaced. The tape applicator described by Kefalos is further limited in its ability to apply tape into a corner section, around corner edges. Further, the device described by Kefalos is limited in that it is designed to apply tape to a surface in only one direction.

A. E. Vidinsky in U.S. Pat. No. 3,740,297 describes a masking tape applicator capable of applying tape into a corner. Vidinsky describes a device having three rollers that act to align the masking tape during application. A roll of tape is loaded onto a spool, pressing an inner side of the roll of tape against a flange of the spool, such that outer ends of the three rollers extend slightly beyond the outside edge of the tape. In order to accommodate rolls of masking tape of various widths, Vidinsky describes the use of spacers having various thickness engaged between an inner edge of the roll of tape and the spool flange. The manual replacement of spacers for each roll of tape is time consuming and use of spacers may make it difficult to achieve precise alignment between the rollers and the outer edge of the tape. Further, when applying tape with the device described by Vidinsky, the device is only operable in one direction.

Longworth, et al. in U.S. Pat. No. 5,269,871 describes a tape applicator having a complex alignment and cutting mechanisms. The device described by Longworth et al. also apparently requires engaging the inner edge of a roll of tape to a flange of a hub adapted for receiving the roll of tape, wherein a manually adjustable means positions the flange at different desired axial positions to thereby position the sides of different width rolls of tape in a desired orientation with respect to the distal ends of application rollers. For the reasons indicated above, among other, a dispenser requiring manual adjustment for each new roll of tape is not preferred. Further, although the device described by Longworth, et al. appears to be operable in either direction, the device is not particularly well suited for applying tape into or around corners.

Several tape dispensers have been described that attach a film, paper, foil etc. to the adhesive side of a roll of tape. For example, Steeves et al. in U.S. Pat. No. 5,445,703, Hunter in U.S. Pat. No. 4,508,587, and Pool in U.S. Pat. No. 4,379,019 each describe a dual dispenser for simultaneous dispensing tape from a roll of tape and a film from a roll of film. The inner diameter of a core of the roll of film is typically substantially smaller than the diameter of a core of the roll of tape. The thickness of an overlapping or folded film is typically greater than the thickness of the tape. Thus, in order for the total length of the tape and film wound on the separate cores and the outer diameter of the two rolls to be approximately equal, the diameter of the core of the film needs to be substantially less than the diameter of the core of the tape.

Söderberg in U.S. Pat. No. 4,915,768 describes a device for applying a covering material. The device described by Söderberg requires two spools that hold rolls of tape for application in opposite directions and does not provide for automatic alignment of an outer edge of a roll of tape independent of the thickness of the roll of tape. Further, although the roll of tape described by Söderberg may include a fold-out foil film attached to the adhesive tape, the core of the tape and film is of a small diameter so that two rolls may be placed on the spools of the device. The inventor of the present invention is not aware of any disclosure of a combination roll of tape and fold-out film that has a core having an inner diameter greater than approximately 1½ inches or 4 cm. Significantly, the inventor has found that by increasing the inner diameter of the core of a roll of tape and fold-out film to be greater than 2 inches or 5 cm, the fold-out film does not have as great a tendency to bunch-up or pucker when wound on the core, and further, the number of windings on the core can be reduced.

Hence, there is a need for a device that automatically aligns the outer edge of a roll of tape/film combination without requiring manual adjustment when switching between widths of tape/film combination, and wherein the device is well suited for taping in and around corners. There is further a need for a combination tape and fold-out film that has decreased winding and compression of the fold-out film on a core of the tape/film combination. The present invention meets these and other needs that will become apparent from a review of the description of the present invention.

### SUMMARY OF THE INVENTION

The present invention provides a portable bi-directional tape dispenser and tape/film combination, wherein the dispenser of the tape/film is capable of conveniently and effectively applying the tape/film around and into corners and along narrow edge surfaces, wherein the application surface may be adjacent to a second surface, such as a wall or framework. The tape-dispensing device further provides for an automatic alignment of an outer edge of the roll of tape/film combination relative to the dispenser, wherein the automatic alignment is independent of the thickness of the roll of tape/film combination.

The dispenser of the present invention generally includes a frame, a hub and an application roller. The hub is rotatably attached to the frame and is adapted for receiving the roll of tape/film. The application roller assists in guiding the tape/film out of the dispenser as tape/film is applied to a surface. Without limitation, in the preferred embodiment the application roller is rotatably attached to the frame, however, it is recognized that the application roller may be rigidly engaged or formed as part of the frame. The dispenser includes at least one alignment member, wherein the outer edge of the alignment member and the outer edge of the roll of tape/film may be aligned in the same plane. Those skilled in the art will appreciate that the application roller may act as the alignment member or one or more separate independent alignment members may extend from the frame. In use, the user preferably places the roll of tape/film on a relatively flat or planar surface, aligns the hub with the core bore of the roll of tape/film, and then presses the hub into the core bore until the selected portion of the dispenser engages the flat surface. In this manner, the outer edge of the roll of tape/film and the selected portion of the dispenser are aligned independent of the width of the roll of tape and without requiring manual adjustments of the alignment member relative to the frame.

Without any limitation intended, the preferred embodiment of the dispenser of the present invention is manufactured from a high impact thermal moldable plastic of known suitable composition and includes two spaced apart alignment members, wherein the application roller is coupled to the dispenser frame between the two alignment members. An angle between the longitudinal axis extending from the first alignment member to the application roller and the longitudinal axis extending from the second alignment member to the application roller is ninety (90) degrees or less. This arrangement provides for a smooth transition in directions when applying the tape into and around corners.

The dispensing device includes a means for holding said dispensing device while dispensing tape there from. Although it is recognized that the means for holding may include a handle attached to a side or end of the dispenser, fingerholds are preferably formed integral with the frame. The fingerholds provide a holding and gripping surface and allows for efficient rotation and other manipulation of the orientation and movement of the dispenser.

In an alternate embodiment of the dispenser, bristles are attached to the frame, wherein the bristles apply pressure to the tape as tape/film is being dispensed from the dispensing device. In another alternate embodiment the hub includes a spring biasing member coupled to the hub. The spring biasing member provides for lateral movement of the hub relative to a longitudinal axis of the frame and/or alignment member. At times, when applying tape to a baseboard or wallboard, the user may wish to have the tape overlap slightly onto the adjacent wall or may desire to have a slight space (of a few thousandths of an inch) between the edge of the tape and the wall. In either instance, the spring biasing member may be utilized to adjust the hub inward or outward.

The bi-directional tape dispenser and tape/film combination of the present invention is capable of applying the tape/film around and into corners. The dispenser includes a serrated cutting member for cutting the tape/film dispensed from the dispenser. The roll of tape/film includes a core, on which the tape/film is wound, that has an inner diameter greater than two inches. The increased diameter of the core reduces bunching and puckering of the film as the tape/film is dispensed. The film of the roll of tape/film has a portion of the film overlapping and attached to a portion of the tape. The film may further be folded several times before winding the tape/film onto the roll or core of the tape/film.

These and other advantages of the present invention will become readily apparent to those skilled in the art from a review of the following detailed description of the preferred embodiment especially when considered in conjunction with the claims and accompanying drawings in which like numerals in the several views refer to corresponding parts.

### DESCRIPTION OF THE DRAWINGS

FIG. 1 is a front perspective view of the tape dispenser system of the present invention;

FIG. 2 is a front elevational view of the tape dispensing system of the type shown in FIG. 1;

FIG. 3 is a back elevational view of the tape dispensing system of the type shown in FIG. 1;

FIG. 4 is a front perspective view of the tape dispensing system of the present invention showing a roll of tape engaged to the hub and having the tape unrolled past the application roller;

FIG. 5 is a front elevational view of the tape dispensing system of the present invention showing a roll of tape engaged to the hub and having the tape unrolled past the application roller for application of the tape in a right to left direction;

FIG. 6 is a front elevational view of the tape dispensing system of the present invention showing a roll of tape engaged to the hub and having the tape unrolled past the application roller for application of the tape in a left to right direction; and

FIG. 7 is a partial perspective side elevational view of the adhesive tape/fold-out film combination partially unrolled and unfolded.

### DETAILED DESCRIPTION

The present invention represents broadly applicable improvements to a tape dispenser suitable for dispensing a tape/fold-out film combination. The embodiments detailed herein are intended to be taken as representative or exemplary of those in which the improvements of the invention may be incorporated and are not intended to be limiting. For purposes of discussion, and without any limitation intended, the tape/foldout film combination of the present invention will be described in conjunction with a preferred embodiment of a dispenser suitable for dispensing the same. Those skilled in the art will appreciate that a variety of other dispensers may be modified to dispense the tape/fold-out film of the present invention.

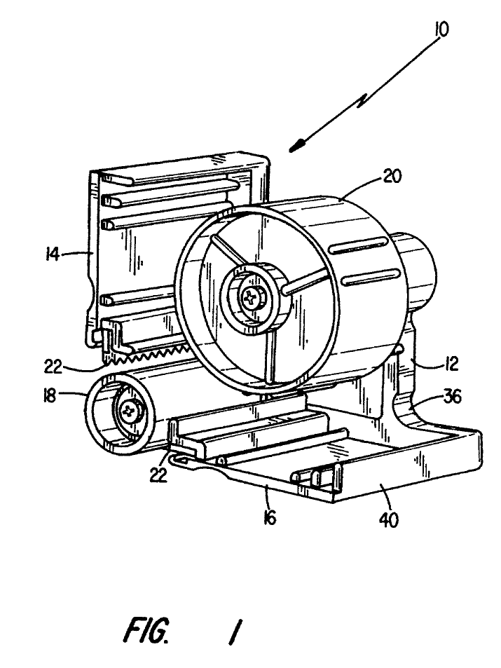

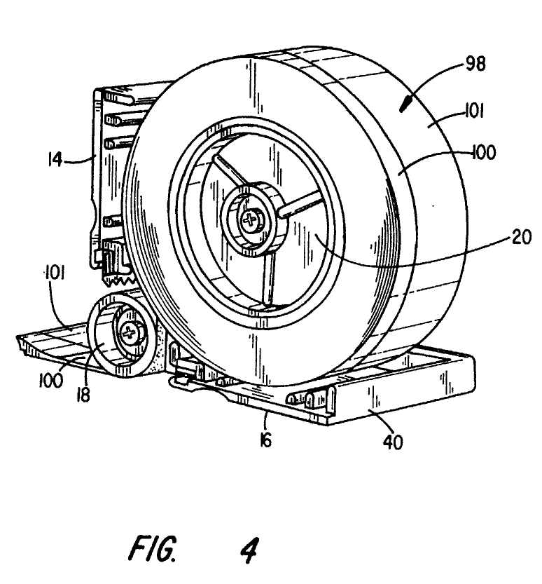

Referring first to FIGS. 1-3, the tape-dispensing device 10 of the present invention is shown. The dispensing device 10 generally includes a frame 12, first alignment member 14, second alignment member 16, application roller 18, hub 20, and cutting members 22. The application roller 18 and hub 20, are preferably rotatably, removably attached to support members. The cutting members 22 are press fit into grooves formed in alignment members 14 and 16 respectively. The grooves further include a channel formed therein and are adapted for receiving post extending from a portion of the cutting member. The cutting members include a serrated edge and are of a known suitable construction.

The frame 12 includes fingerholds 36 formed in the frame 12 and alignment members 14 and 16, and fingerholds or wing members 38 extending from the frame 12. The fingerholds 38 are well suited for positioning the middle and index fingers thereon, while resting the thumb and fifth finger in the fingerholds 36. The fingerholds 36 and 38 are positioned around the frame 12 in strategic positions to facilitate the handling and maneuvering of the device 10. The frame 12 may further include ribs 40 extending from planar surfaces of the frame 12 to provide added support and rigidity to the frame 12. The hub 20 includes ribs 42 extending outwardly from an outer circumferential surface of the hub 20. The ribs 42 are designed to engage an inside surface of a core of the roll 98 of tape/film 99 (shown in FIGS. 4-7).

Without any limitation intended, the preferred mode of rotatably coupling the hub 20 and application roller 18 to the frame 12 is described in greater detail in co-pending application Ser. No. 09/374,406 filed Aug. 13, 1999, the entire disclosure of which is incorporated herein by reference. The hub 20 rotates or freely spins about a support member, but includes a fastener that prevents the hub 20 from spinning off the support member. Without any limitation intended the fastener may include a bolting mechanism, rivets, snap fit or other suitable known fastener. Similarly, the application roller 18 rotates or freely spins about a support member and is also attached by known suitable fasteners to prevent the application roller 18 from spinning off the support member.

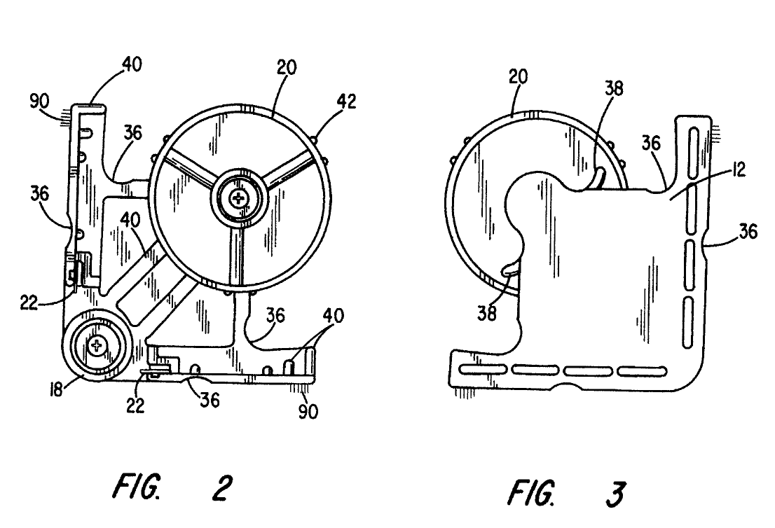

Soft flexible bristles 90 are shown in FIG. 2 extending from first and second alignment members 14 and 16. When tape/film 99 is dispensed from the dispenser 10 the bristles 90 provide added pressure against the tape 100 of the tape/film 99, thereby promoting the adhesion of the tape 100 to the underlying surface. As shown in FIG. 7, roll 98 of tape/film 99 comprises a tape 100 and film 101, wherein an edge of the film 101 overlaps an edge of the tape 100. The adhesive on the tape, engages that portion of the overlapping film 101 to that portion of the tape 100. Those skilled in the art will appreciate that the film 101 may be constructed from a paper, polymer, foil, or other material of known suitable construction. The film 101 may have a width greater than the width of the core 103 of the roll 98 of the tape film 99. When the width of the film 101 exceeds the width of the core 103, the film may be folded one or more times and then wound onto the core 103.

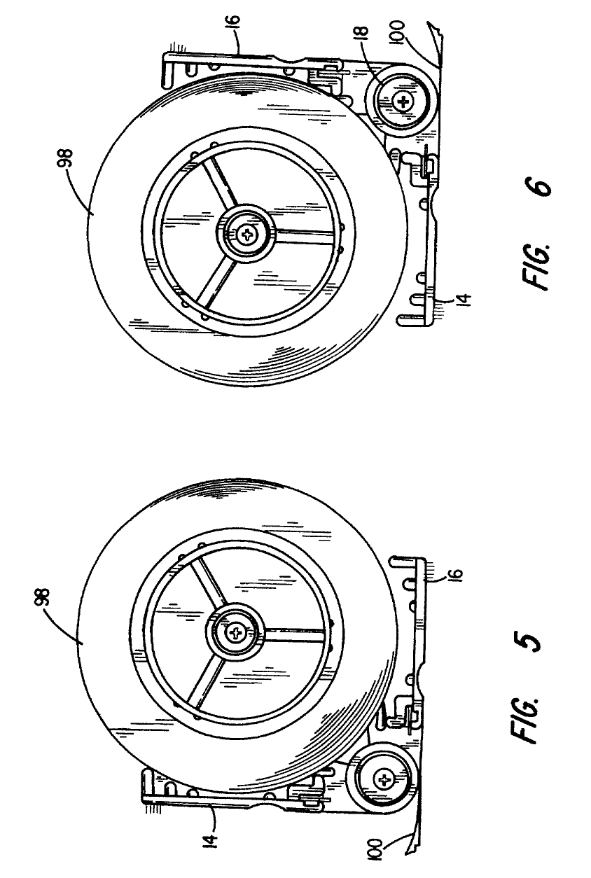

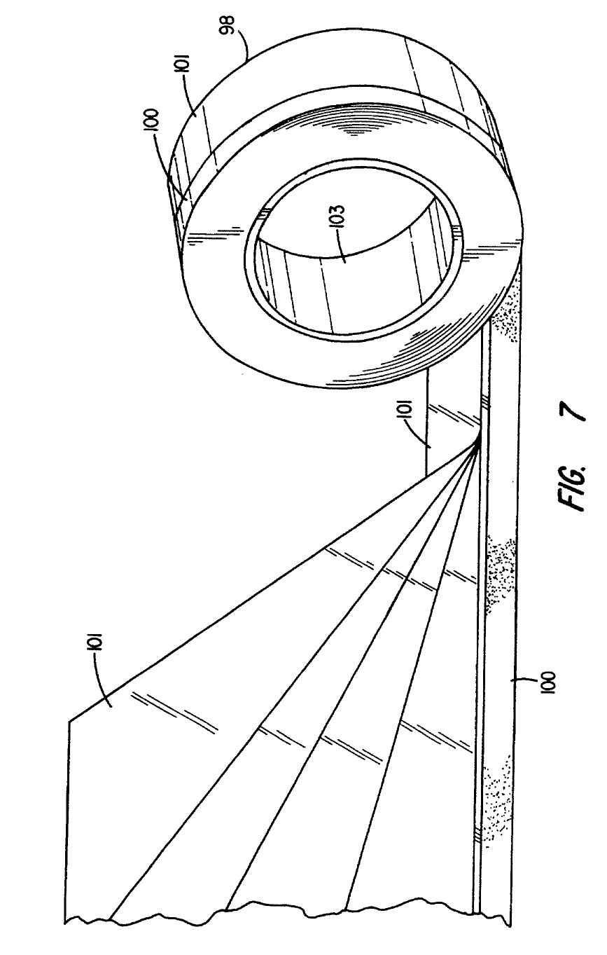

Having described the constructional features of the present invention the mode of use will be described in greater detail in conjunction with a description of FIGS. 4-6. In FIGS. 4-6, the roll of tape 98 is shown press fit onto the hub 20 with the tape 100 and film 101 being unrolled from the roll 98. The adhesive side of the tape 100 faces downward and the tape is threaded under the application roller 18. As described above, the edge of the tape aligns with one or more of the application roller 18, the frame 12, and alignment members 14 and 16. FIGS. 5 and 6 show that the pathway of the tape/film 99 may be dispensed bi-directionally from the dispenser 10. The pathway shown in FIG. 5 is preferred when the tape/film 99 is applied in a right to left direction. FIG. 6 shows the pathway of the tape/film 99 through and out the dispenser 10 when the tape/film 99 is applied in a left to right direction.

The application of tape/film 99 into the corner of a framework is described sequentially below. First, the user applies the tape/film 99 to the desired surface and towards the corner. As the dispenser is moved into the corner of the framework the dispenser is rotated so that the alignment member 14 moves from a horizontal position to a vertical position. The user then presses the dispenser 10 into the corner and then the dispenser is moved upward in the vertical direction along the framework. Those skilled in the art will appreciate that if an exact fit of the tape into the corner is desired, when the user presses the dispenser 10 into the corner a utility knife may be positioned between the tape/film 99 and alignment member 16 and then slid into the corner, thereby pressing the tape/film 99 tight into the corner. Those skilled in the art will further appreciate that the radius of the application roller may be reduced to minimize the radius of the tape/film 99 positioned in the corner.

Likewise, the dispenser of the present invention may be utilized to apply the tape/film 99 around the corner of framework. The user first applies the tape/film 99 towards the corner. As the dispenser is moved towards the corner of the framework the dispenser is rotated so that the alignment member 14 moves from a vertical position to a horizontal position. The user then presses the dispenser 10 towards the edge until only a portion of alignment member 14 overlaps with the framework. The dispenser 10 is then rotated downward around the corner and then the user moves the dispenser downward in the vertical direction along the framework. The user may again rotate the dispenser ninety (90) degrees so that the leading edge of alignment member 16 is adjacent the framework.

Once the desired amount of tape/film 99 has been applied, the user may separate the dispensed tape/film 99 from the remainder of the roll 98 using the cutting member 22. The film 101 may be unfolded to further protect the surface adjacent the area on which the tape 100 adheres.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

What is claimed is:

1. A bi-directional tape dispenser and tape/film combination capable of applying said tape/film around and into corners of a first surface and positioned adjacent to a second surface, said tape dispenser and tape/film combination comprising:
a frame having an alignment member positioned on said frame; and
a hub rotatably attached to said frame and adapted for receiving a roll of tape/film, wherein an outer edge of the roll of tape/film aligns with an outer edge of said alignment member, and further wherein said roll of tape/film may be pressed onto the hub with the edge of said roll of tape/film being oriented on said bi-directional tape dispenser independent of a thickness of said roll of tape/film.

2. The bi-directional tape dispenser and tape/film combination as recited in claim 1 further including a second alignment member extending from said frame and spaced apart from said alignment member.

3. The bi-directional tape dispenser and tape/film combination as recited in claim 1, further including bristles attached to said frame, wherein said bristles apply pressure to a portion of said tape/film as it is being dispensed from said dispensing device.

4. The bi-directional tape dispenser and tape/film combination as recited in claim 1, further including a serrated cutting member for cutting the tape and film dispensed from said dispensing device.

5. The bi-directional tape dispenser and tape/film combination as recited in claim 2, wherein an angle between a longitudinal axis of said alignment member and a longitudinal axis of said second alignment member is less than ninety (90) degrees.

6. The bi-directional tape dispenser and tape/film combination as recited in cl aim 1, wherein said roll of tape/film includes a core, on which the tape/film is wound, having an inner diameter greater than two inches.

7. The bi-directional tape dispenser and tape/film combination as recited in claim 1, wherein said roll of tape/film includes a film having a portion of said film overlapping and attached to a portion of said tape.

8. The bi-directional tape dispenser and tape/film combination as recited in claim 7, wherein said roll has an inner diameter greater than two inches.

9. The bi-directional tape dispenser and tape/film combination as recited in claim 7, wherein said film includes multiple folds.

10. The bi-directional tape dispenser and tape/film combination as recited in claim 1, wherein said edge of said roll of tape/film is oriented relative to said alignment member.

11. The bi-directional tape dispenser and tape/film combination as recited in claim 1, wherein said edge of said roll of tape/film is oriented relative to said frame.

12. The bi-directional tape dispenser and tape/film combination as recited in claim 1, wherein said edge of said roll of tape/film is oriented relative to said application roller.

13. The bi-directional tape dispenser and tape/film combination as recited in claim 1, wherein said edge of said roll of tape/film is oriented relative to said alignment member by aligning said roll with said hub and pressing said edge of said roll of tape/film against a relatively planar surface until a portion of the alignment member contacts the relatively planar surface.

14. The bi-directional tape dispenser and tape/film combination as recited in claim 1, wherein said edge of said roll of tape/film is oriented relative to said frame by aligning said roll with said hub and pressing said edge of said roll of tape/film against a relatively planar surface until a portion of the frame contacts the relatively planar surface.

15. The bi-directional tape dispenser and tape/film combination as recited in claim 1, wherein said edge of said roll of tape/film is oriented relative to said application roller by aligning said roll with said hub and pressing said edge of said roll of tape/film against a relatively planar surface until a portion of the application roller contacts the relatively planar surface.

16. A tape/film combination suitable for dispensing around and into corners of a first surface and positioned adjacent to a second surface, said tape/film combination comprising:
a core on which a tape and film are wound, having an inner diameter greater than two inches;
a portion of said film overlapping and attached to a portion of said tape;
said tape/film combination is suitable for use in a dispenser, wherein said tape/film combination may be pressed onto said dispenser with an edge of said tape/film combination being oriented relative to said dispenser independent of a thickness of said tape/film combination.

17. The tape/film combination as recited in claim 16, wherein said film includes multiple folds.

18. The tape/film combination as recited in claim 16, wherein said edge of said tape/film combination being oriented relative to an alignment member of said dispenser.

19. The tape/film combination as recited in claim 16, wherein said edge of said tape/film combination is oriented relative to a frame of said dispenser.

20. The tape/film combination as recited in claim 16, wherein said edge of said tape/film combination is oriented relative to an application roller of said dispenser.

21. The tape/film combination as recited in claim 16, wherein said edge of said tape/film combination is oriented relative to an alignment member of said dispenser by aligning said tape/film combination with a hub of said dispenser and pressing said edge of tape/film combination against a relatively planar surface until a portion of the alignment member contacts the relatively planar surface.

22. The tape/film combination as recited in claim 16, wherein said edge of said tape/film combination is oriented relative to a frame of said dispenser by aligning said tape/film combination with a hub of said dispenser and pressing said edge of said tape/film combination against a relatively planar surface until a portion of the frame contacts the relatively planar surface.

23. The tape/film combination as recited in claim 16, wherein said edge of said tape/film combination is oriented relative to an application roller of said dispenser by aligning said tape/film combination with said hub and pressing said edge of said tape/film combination against a relatively planar surface until a portion of the application roller contacts the relatively planar surface.
